(19) United States
(12) Patent Application Publication
(10) Pub. No.: US 2003/0031322 A1
(43) Pub. Date: Feb. 13, 2003

(54) Method for conveying encryption information to parties in a multicast group

(76) Inventors: Mark Beckmann, Braunschweig (DE); Martin Hans, Hildesheim (DE); Michael Eckert, Braunschweig (DE); Andreas Otte, Celle (DE)

Correspondence Address: Bell, Boyd & Lloyd LLC, P.O. Box 1135, Chicago, IL, 60690, US

(21) Appl. No.: 10/213,665

(22) Filed: Aug. 7, 2002

(30) Foreign Application Priority Data
Aug. 7, 2001 (DE) 101 38 718.0

(51) Int. Cl. H04L 9/00

(52) U.S. Cl. 380/278; 713/168; 713/163

(57) ABSTRACT

A method for conveying encryption information to parties in a multicast group in a mobile radio network is provided which is distinguished by the fact that a cipher key and a current encryption sequence number or parts of such a sequence number are transmitted via an air interface, via a connection already protected against interception by unauthorized persons which is allocated as dedicated to the receiver of the encryption information.

### BACKGROUND OF THE INVENTION

To provide a better understanding of the present invention and of the problem on which it is based, the anatomy of a UMTS (universal mobile telecommunication system) network first will be described schematically with reference to FIGS. 1 to 7.

FIG. 1 shows the UMTS protocol architecture of the second layer and the lower third layer which contain the protocols of the UMTS air interface. This architecture is present both in the user equipment (UE) and in a node of the mobile communication network (radio network controller, RNC). As such, each of the protocols exists once in the UE and once in the RNC. The area to the left of the dashed line relates to the C-plane signaling and the area on its right relates to the U-plane information.

Each of the protocol layers shown in FIG. 1 provides its services to the layer above it at so-called service access points. To provide a better understanding of the architecture, these service access points are provided with names which are generally used and are unambiguous such as, e.g., logical channels, transport channels, radio bearers and signaling radio bearers. The protocol layers shown in FIG. 1 are:

the radio resource control (RRC) or lower third layer 2

the packet data convergence protocol (PDCP) or upper second layer 4

the broadcast/multicast control (BMC) or upper second layer 6

the radio link control (RLC) or middle second layer 8

the medium access control (MAC) or lower second layer 10

and the physical layer (PHY) 12.

In general, it is possible to generate data of different applications in the UMTS user equipment (UE). For voice connections, for example, a voice encoder generates one or more voice datastreams or an HTML browser generates irregular packet datastreams. These data first may be modified by higher-layer protocols and prepared for data transfer in various networks; e.g., TCP and IP. For the transport via the UMTS air interface, these data must be optimized in the various protocols of the second layer PDCP 4, BMC 6, RLC 8 and MAC 10. The service access point at which non-UMTS-specific protocols can use the transmission service of the UMTS air interface is called the radio bearer (RB) 14. RBs 14 are thus provided above the second layer depending on protocols used above PDCP 4, BMC 6 or RLC 8 and transmit data transparently from the UE via the UMTS air interface to the RNC and conversely. The service access point at which the UMTS-specific RRC protocol uses the transmission service of the UMTS air interface is called the signaling radio bearer (SRB) 16.

RBs 14 and SRBs 16 can be both bidirectional and unidirectional. Thus, they can transmit data either in two directions (in the uplink (UL) and in the downlink (DL)) or only in one direction (UL or DL).

However, in transmitting information or data via the UMTS air interface, a security problem arises since, in general, data which are transmitted via an air interface can be potentially intercepted or monitored by unauthorized persons. The data passing via the RBs 14 to the second layer 4, 6, 8, 10 of the UMTS protocol architecture are, therefore, protected against interception by unauthorized persons in that they are encrypted before they are sent via the air interface. For the encryption, an encryption key is used which is specific to every mobile radio subscriber and is negotiated individually between the network and the UE with each call set up. However, it also can be newly negotiated during an existing call. This individual negotiation of an encryption key for each individual mobile radio subscriber is only appropriate, however, for those data which are only intended for a single user.

In the case of data being transmitted not only to one mobile radio subscriber but to a number of subscribers at the same time as is usually done in multicasting involving parties in a multicast group, there are firstly two possibilities of doing this.

On the one hand, the data simply can be copied and sent to the corresponding mobile radio subscribers via separate channels. Although it is possible in this case to use the encryption key, which is individually negotiated for each mobile radio subscriber, to protect against unauthorized interception of the data, this method wastes transmission capacity to a certain extent since a separate channel must be provided for each party in a multicast group.

It is, therefore, more appropriate not to duplicate the data and send them via separate channels but to transport them via the air interface via a single channel which is jointly received by all parties in the multicast group. In this case, however, none of the individually negotiated encryption keys of the parties in the multicast group can be used for encrypting the data because each encryption key is properly only known to the relevant UE and the remaining parties thus cannot decrypt the received data.

To generate and negotiate an individual encryption key, the following procedure is known. The encryption key is generated and negotiated between the UE and the network during a so-called authentication procedure which is run at least at the beginning of each call set up. In addition, however, it also can be started during a call, initiated by the network operator. The procedure is based on a network architecture according to FIG. 2 and mainly involves the home environment (HE) 20, the serving GPRS support node (SGSN) 22 and the UE 18. The authentication procedure assumes that the transmission of information via interfaces on the other side of the Uu interface 24 is secure; that is to say, it cannot be intercepted in any form by unauthorized persons. Furthermore, it should be mentioned here that the authentication procedure is generally used not only for generating and negotiating an encryption key but also for mutual authorization of UE and network in order to be allowed to exchange data with one another, and for generating and negotiating an integrity key, by the use of which the integrity of the received data is confirmed to the receiver. The integrity key, however, will not be discussed further in the text which follows because integrity protection is only applied to signaling data and not to user data in the UMTS.

After a UE 18 has been switched on, it first establishes a link to the Universal Terrestrial Radio Access Network (UTRAN) 26 by a signaling link being set up between the RRC protocol layers 2 in the RNC 28 and UE 18. To set up such a signaling link, the RRC 2 in the RNC 28 is informed by the UE 18 of, among other things, the identity number (e.g., IMSI) of the mobile radio subscriber, the capability of the UE 18 to support certain security procedures, and the starting values of particular hyper frame numbers (HFNs) which are of significance to the actual encryption procedure. If a signaling link exists between UE 18 and UTRAN 26, the UE 18 registers with the core network (CN) 30 in the next step by setting up a further signaling link to the SGSN 22. For this connection set up, the SGSN 22 is also informed of the identification number of the mobile radio subscriber, among other things. This identity number is used for identifying the mobile radio subscriber in the network as a result of which all subscriber-specific data and information items stored in a list in the home location register (HLR) 32 can be made known to the network units such as, e.g., RNC 28, SGSN 22, GGSN 34, etc., if necessary. A subscriber-specific information item stored in the HLR 32 is, e.g., a special security code (K) which is also stored in the Universal Subscriber Identity Module (USIM) in the UE 18, and is needed for generating the encryption key.

After a signaling link has been set up between UE 18 and CN 30, the authentication procedure, the signaling sequence of which is shown in FIG. 3, is started by the SGSN 22 sending an authentication data request 38 to the HE 20. This request contains the identity number of the mobile radio subscriber for which an authentication procedure is to be performed. After the reception of the request 38, a certain number of data records (authentication vectors, AVs), which are needed for generating the encryption key, are generated in the HE 20 or, respectively, the authentication center (AuC) 36 which, like the HLR 32, is contained in the HE 20.

For each authentication procedure, a single data record or AV is used. FIG. 4 shows how the individual parameters of an authentication vector are generated.

The AuC 36 first generates a new sequence number of the HE (SQNhe) 40; i.e., a sequence number which has not yet occurred and a random number RAND 42 which cannot be reproduced. The HE 20 keeps a specific SQNhe 40 for each subscriber and updates it when necessary. The AuC 36 then calculates the parameters needed for the AV, the individual parameters being calculated with the aid of special functions called f1 to f5 in FIG. 4. Calculation of the parameters XRES, CK, 1K and AK requires only the random number RAND and the subscriber-specific security code K 55 of which the AuC 36 is informed by the HLR 32 via the identity number of the subscriber. XRES (expected response) 44 is a reference value which is expected by the network as response of the UE 18 to the authentication procedure, CK (cipher key) 46 is the encryption key, IK 48 is the aforementioned integrity key and AK 50 is an anonymity key. Calculation of the message authentication code (MAC) 52, via which the authorization of UE 18 and network is checked during the authentication procedure, additionally also requires the sequence number SQNhe generated by the AuC 36 and an authentication management field (AMF) 54. The AMF 54 can fulfill different functions. After calculation of the five parameters (MAC 52, XRES 44, CK 46, IK 48, AK 50), the AuC 36 also generates an authentication token (AUTN) which is composed of a concatenation of the SQNhe encrypted with the AK 50, the AMF 54 and the MAC 52. The sequence number SQNhe is encrypted with the AK 50 because the identity number and the location of the subscriber could be derived from it under certain circumstances. From the parameters generated, the AV is then formed by appending the individual parameters to one another in the following order:

AV:=RAND∥XRES∥CK∥IK∥AUTN

where

AUTN:=SQNhe⊕AK∥AMF∥MAC

where the symbol “∥” symbolizes the concatenation of the individual parameters and “⊕” symbolizes a logical XOR operation. A number of these AVs sorted in accordance with their sequence numbers SQNhe used for the calculation are then sent back by the HE 20 as authentication data response 56 to the SGSN 22 which stores them in its visitor location register (VLR) 56.

If AVs are stored in the VLR 58 of the SGSN 22, the SGSN 22 selects the AV which was generated with the lowest SQNhe and sends a user authentication request 59 to the UE 18 which contains the parameters RAND 42 and AUTN 62 of the selected AV. After receiving the request, the UE 18 begins to calculate an expected message authentication code (XMAC) 60 with the aid of the parameters contained therein, as shown, among other things, in FIG. 5. These and the subsequent calculations, too, occur in the universal subscriber identity module (USIM) of the UE 18. The USIM firstly calculates, from the random number RAND 42 contained in the request and the security code K 55 stored in the USIM, the anonymity key AK 50 in order to use it to decrypt the SQNhe contained in the AUTN 62. Following this, the XMAC 60 is generated from the previously calculated SQNhe, the security code K, the random number RAND 42 and the AMF 54, also contained in the AUTN 62. This is then compared with the MAC 52 received in the AUTN 62 and calculated by the network (HE 20/AuC 36). If XMAC 60 and MAC 52 are identical, the UE 18 and the network have authorized each other to continue to exchange data with one another. If XMAC 60 and MAC 52 are not identical, an authentication error occurs. Since the UE 18 is now authorized to exchange data with the network, the UE 18 checks whether it is operating synchronously with the network with respect to the sequence number by comparing its own sequence number SQNms (sequence number of the mobile station) with that of the network (SQNhe). If SQNhe is within a tolerated range around SQNms, the USIM lastly calculates the response to the user authentication request, the value RES (response) 64, and the keys CK 46 and IK 48 needed for the further call set up. If SQNms and SQNhe are too far apart, another authentication error occurs.

If the calculations described above have been successfully performed in the USIM, the UE 18 sends as user authentication response 57 the parameter RES 64 to the SGSN 22 which compares it with the XRES 44 parameter contained in the corresponding AV. If the two parameters are identical, the authentication procedure is thus concluded and the SGSN 22 and the UE 18 establish the two negotiated keys CK 46 and IK 48. As such, at the network end, the keys CK 46 and IK 48 contained in the AV are transported from the SGSN 22 to the RNC 28 where the actual encryption and integrity algorithms are executed. If the two parameters differ from one another, another authentication error occurs, followed by the appropriate response. In general, the SGSN 22 can decide after each authentication error whether it starts a new authentication procedure with a new AV from the VLR 58 or whether it reports the error to the HE 20.

Since the cipher key CK 46 has now been negotiated and transported from the SGSN 22 to the RNC 28, the RNC 28 can use it immediately, as a result of which any further communication between the network and UE 18 can be carried out under interception-proof conditions.

The actual encryption and decryption procedure is shown with all parameters in FIG. 6. Depending on the configurations of the individual protocol units of the second layer which have been undertaken, it can be carried out either in the radio link control (RLC) 8 or in the medium access control (MAC) 10. If the encryption of the user data is carried out, e.g., in the RLC 8, the decryption at the receiver end correspondingly also takes place in the RLC 8.

The core of the encryption procedure is the encryption algorithm f8, indicated in FIG. 6, which will not be discussed in detail further below. Apart from the cipher key CK 46 negotiated during the authentication procedure, the input parameters for this algorithm are also the parameters BEARER 66, DIRECTION 68, LENGTH 70 and COUNT-C 72. BEARER 66 represents the identity of RB 14 via which the user data to be encrypted reach the second layer and DIRECTION 68 represents the direction in which the data are transmitted (UL or DL). The parameter LENGTH 70, in contrast, exclusively specifies the length of the encryption code (KEYSTREAM BLOCK) 74 generated by the algorithm f8 and the COUNT-C value 72 is a time-dependent parameter which will be described in greater detail below.

On the basis of these input parameters, the algorithm f8 generates the KEYSTREAM BLOCK 74 which has the same length as the data block which is to be encrypted and sent to the receiver with a transmission interval. The characteristic of the input parameters ensures that a new encryption code is always generated for each data block newly to be encrypted. In other words, each data block is encrypted with a specific encryption code. Unauthorized persons are thus unable to draw conclusions with regard to the cipher key CK 42 from the reception of a number of successive encrypted data blocks, and the cipher key additionally changes from time to time as already described initially if a new authentication procedure is started, initiated by the network operator. The reference symbol 75 designates a plain text block and 77 designates a cipher text block.

The actual encryption of the data block then only consists of a simple logical XOR operation on the data bits with the bits of the encryption code. This completes the encryption of a data block and it can be handed to the next protocol unit or protocol layer for further processing. In the receiver, for each encrypted data block, the associated encryption code is calculated in the same manner as in the transmitter and it is ensured that the input parameters of the encryption algorithm are identical. Decryption is then again achieved by a simple logical XOR operation.

The abovementioned parameter COUNT-C 72 is a time-dependent parameter which has the function of an encryption sequence number since it is incremented by one after each encryption of a data block. For each RB 14, the RLC unit 8 of which has been configured for the unacknowledge mode (UM) 76 or the acknowledge mode (AM) 78, a separate COUNT-C 72 value is set up for each direction of transmission (UL or DL). There are, thus, two COUNT-C values 72, e.g., for a bidirectional RB 14. For all RBs 14, the RLC units 8 of which were configured for the transparent mode (TrM) 80, in contrast, there is only a total of two COUNT-C values 72, in each case one being provided for each direction of transmission (UL and DL). It should be noted at this point that, in the case where the RLC unit 8 of a RB 14 operates in TrM 80, the encryption of the user data takes place in the MAC 10 of the second layer of the UMTS protocol architecture.

The COUNT-C parameter 72 has a constant length of 32 bits but these can be differently composed for each RB 14 depending on the three RLC modes mentioned, as shown in FIG. 7. In general, COUNT-C 72 is composed of a short and a long sequence number (SQN), the short SQN occupying the least significant bits (LSB) and the long SQN occupying the most significant bits (MSB). The long SQN is an aforementioned hyper frame number (HFN), the length of which is dependent on the mode in which the corresponding RLC unit 8 is operating.

During a call set up, the 20 MSBs of the HFNs are configured with a so-called START parameter and the remaining bits are set to zero. This START parameter is a measure of the validity period of the cipher key CK 46 currently used. If the START value reaches a threshold value predetermined by the network operator, a new authentication procedure is initiated and thus a new cipher key is negotiated and established which is associated with the START value being reset to zero. The 20 MSBs of the COUNT-C value 72 with the highest value of all COUNT-C values 72 form the current START value at any time. When a connection is cleared down, the current START value is stored in the USIM of the UE 18 so that this can be used for reconfiguring the HFNs in a new call set up. During an existing call, the HFNs are incremented by the carries generated by the short SQN of the corresponding COUNT-C parameter 72. In other words, when the short SQN of a COUNT-C value jumps to zero from its highest possible value (overflow), the value of the corresponding HFN of the COUNT-C value 72 increases by one.

Depending on the three RLC modes mentioned, the short SQN is either the RLC SQN of the RLC unit belonging to the RB which is incremented for each data packet to be sent via the air interface, or the MAC SQN as can be seen in FIG. 7. The MAC SQN which is incremented for each beginning transmission interval in which the data packets are transmitted via the air interface is called the connection frame number (CFN). It should be noted that the RLC SQNs and the CFN, and thus also the HFNs of the COUNT-C parameters 72, are subscriber-oriented because their value depends on the amount of data exchanged between the network and UE 18.

Using the procedure described above and normally used in UMTS, however, it is not possible to protect data which are intended simultaneously for a particular number of mobile radio subscribers as is the case in multicasting, and which are to be sent via a single channel, against interception by unauthorized persons via a cipher key which is jointly known to the corresponding parties.

It is then an object of the present invention to provide a method via which the problems of the prior art with respect to the generation and distribution of cipher keys can be circumvented with respect to the parties in a multicast group, and which can be implemented in the simplest and most economical manner possible.

### SUMMARY OF THE INVENTION

A method for conveying encryption information to parties in a defined group is provided which is distinguished by the fact that a cipher key and a current encryption sequence number or parts of such a sequence number are transmitted via an air interface, via a connection already protected against interception by unauthorized persons. In this method, the encryption information is sent to each party in a defined group via a channel dedicated to the party, which is protected against interception by unauthorized persons by the subscriber-oriented encryption parameters (CK 46, COUNT-C 72, . . . ).

The method according to the present invention preferably contains the use or introduction of group-specific cipher keys and group-specific encryption sequence numbers.

The method according to the present invention also can be arranged in such a manner that the data of a number of multicast groups are sent time-interleaved via the same transmission channel.

The method also can be arranged in such a manner that the interrogation as to whether a subscriber is authorized to receive messages of the requested MCG is directed directly to the multicast center by the radio network controller (RNC).

The special advantage of the present invention is that it makes it possible to transmit data which are to be sent to a particular number of mobile radio subscribers, particularly to parties in a multicast group, via a common transmission channel and at the same time to protect them against interception by unauthorized persons. This makes it possible to save transmission capacities since it is not necessary to set up a separate transmission channel for each party in a group, especially if the data of a number of multicast groups are sent time-interleaved via the same transmission channel.

By transmitting the cipher key and a current encryption sequence number via a connection which is already secure, the present invention has the advantage that these parameters are protected against interception by unauthorized persons and are thus known only to the parties in a group and the corresponding network units in which the parameters are needed or generated or administered.

The present invention furthermore has the advantage that a mobile radio subscriber who belongs to a defined group, particularly a multicast group, is enabled to receive group-specific data even though the user equipment has not been active since the beginning of the transmission of data to the message group but only becomes ready for reception during an ongoing transmission.

Additional features and advantages of the present invention are described in, and will be apparent from, the following Detailed Description of the Invention and the Figures.

### BRIEF DESCRIPTION OF THE FIGURES

FIG. 1 shows the UMTS protocol architecture of the second and lower third layer of the UMTS air interface (prior art).

FIG. 2 shows the network architecture of an authentication procedure (prior art).

FIG. 3 shows the progress of the authentication procedure (prior art).

FIG. 4 shows the scheme for generating the individual parameters of an authentication vector (prior art).

FIG. 5 shows the calculation of a messaging authentication code (prior art).

FIG. 6 shows the encryption algorithm of the encryption procedure (prior art).

FIG. 7 shows the composition of the COUNT-C parameter (prior art).

FIG. 8 shows the network architecture of an authentication procedure according to the present invention (prior art).

FIG. 9 shows the diagrammatic representation of the progress of a possible authentication procedure according to the present invention.

FIG. 10 shows the diagrammatic representation of the progress of a variant of the authentication procedure according to the present invention.

FIG. 11 shows the diagrammatic representation of the progress of a third authentication procedure according to the present invention.

### DETAILED DESCRIPTION OF THE INVENTION

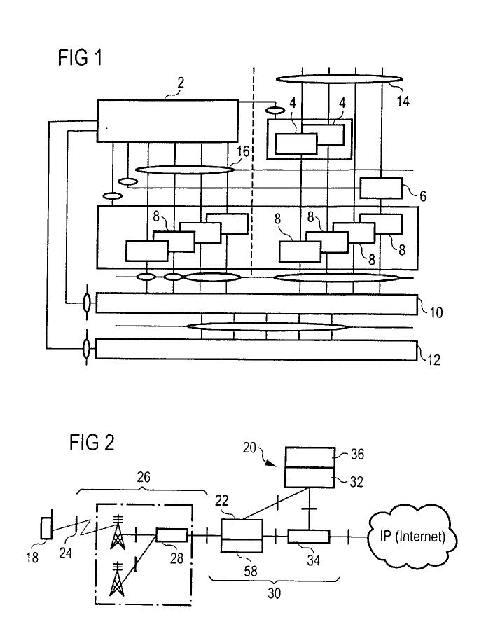

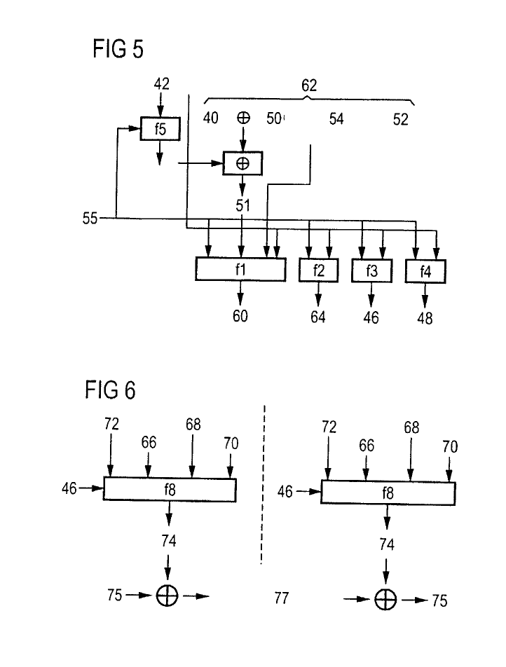

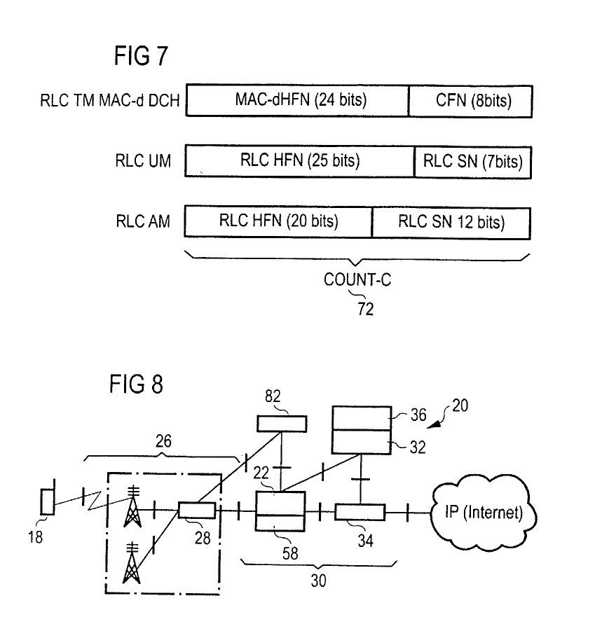

FIGS. 1 to 7 already have been discussed in conjunction with the discussion of the prior art. They do not, therefore, need to be discussed again.

The exemplary embodiments described below presuppose that a mobile radio subscriber is at least registered in a multicast group (MCG). In other words, the network has the information that the mobile radio subscriber is authorized to receive messages which are only directed to parties in a particular MCG.

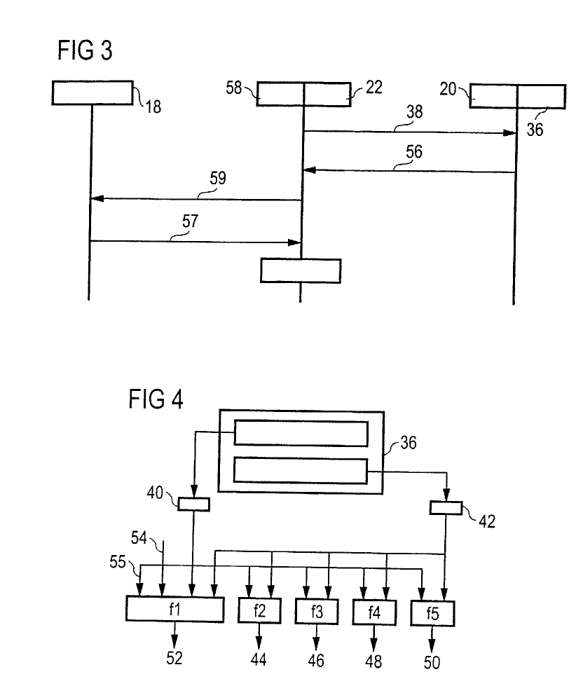

It is also assumed that the messages which are sent to an MCG are sent via a common transmission channel and are, therefore, encrypted with a multicast group cipher key (MCG CK) in order to protect them against interception by unauthorized persons. The MCG CK and other parameters needed for generating an encryption code (KEYSTREAM BLOCK 74) are assumed to be not yet known to the UE 18. It is also assumed that the UE 18 of the mobile radio subscriber has already set up a call to the UTRAN 26 and to the CN 30 and, thus, an authentication procedure as described with regard to FIG. 3 for the prior art already has been performed. In other words, the keys CK 46 and IK 48 specific to the UE 18 already have been negotiated between the network and UE 18, as a result of which the subscriber-oriented information exchanged between network and UE 18 is protected against interception by unauthorized persons.

The following descriptions of the sequence of the negotiation of the MCG CK between network and UE 18 are based on a network architecture according to FIG. 8.

Assuming that a mobile radio subscriber wishes to receive messages from an MCG which is already active, the UE 18 of the subscriber firstly needs the MCG CK and the current COUNT-C value 72 of the RB 14 via which the messages are transmitted. These parameters are needed by the UE 18 in order to be able to correctly calculate the KEYSTREAM BLOCK 74 which is needed for decrypting the message. The remaining parameters (BEARER 66, DIRECTION 68 and LENGTH 70) which are needed for calculating the KEYSTREAM BLOCK 74 can be determined by the UE 18 itself via the configurations made for receiving multicast messages. Once these parameters are known to the UE 18, it can successfully decrypt all subsequent messages by updating the parameters after each received message in accordance with the prior art.

Since the MCG CK is a cipher key which is used jointly by a number of mobile radio subscribers, it cannot be individually negotiated between network and UE 18 as is the case in the prior art. The information about the currently used MCG CK must be conveyed to the mobile radio subscriber by the network; i.e., the actual MCG CK must be transmitted to the UE 18 via the air interface.

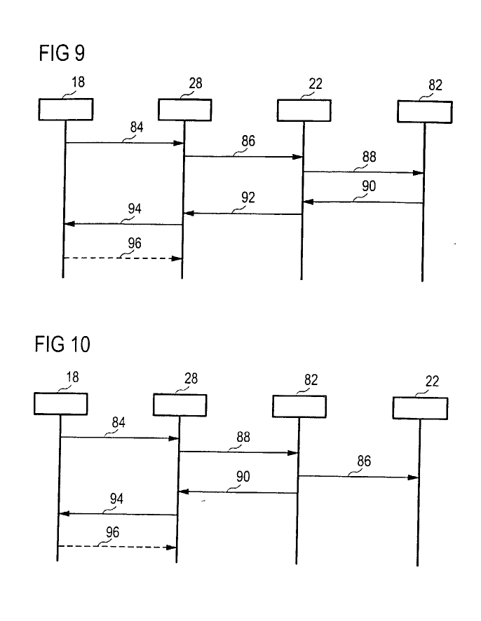

In FIG. 8, a subscriber authentication and cipher key administration by the multicast center is described. This assumes that the multicast center (MCC) 82 which is responsible for generating and distributing MC messages has the capability for subscriber authentication and the function for generating the MCG CK. The MCC 80 thus contains the information as to which MCG CK of an MCG is valid at a particular time. So that the MCG CK is conveyed to the UE 18 by the network, it first sends an MCG entry request 84 to the RNC 28 as shown in FIG. 9. This request contains the identity of the mobile radio subscriber (user ID) and the identity of the MCG (MCG ID) which the mobile radio subscriber wishes to join.

If the RNC 28 receives a message of the MCG entry request 84 type, it signals to the SGSN that a mobile radio subscriber wishes to join an MCG in the coverage area of the RNC 28. For this purpose, the RNC 28 sends a message of the MCG entry indication 86 type to the SGSN 22 which again contains the user ID and MCG ID parameters. Once the SGSN 22 has received such a message, it inquires from the MCC 82 whether the corresponding subscriber is authorized to join the requested MCG. The SGSN 22 achieves this by sending an MCG authentication request 88 to the MCC 82 which also contains the identity of the mobile radio subscriber and the identity of the MCG. If the MCC 82 receives an MCG authentication request, it checks via the identity of the mobile radio subscriber whether he/she is authorized to join the requested MCG. If this is so, the MCC 82 determines the currently valid MCG CK of the requested MCG and sends it together with the user ID and MCG ID parameters in an MCG authentication response message 90 to the SGSN 22. The SGSN 22 can then perform the necessary configurations which enable the network operator to determine the charges incurred by the mobile radio subscriber by using the MC service. Furthermore, the SGSN 22 forwards the information received from the MCC 82 to the corresponding RNC 28 in an MCG entry aware message 92. Once the RNC 28 has received the MCG CK from the SGSN 22, it determines the current MCG-specific COUNT-C value (MCG COUNT-C) 72 which is used for calculating the next KEYSTREAM BLOCK 74. If the RNC 28 has already supplied another party of the MCG with MC messages, the information about the MCG COUNT-C value 72 exists in the corresponding protocol unit which performs the encryption of the MCG data. If no further parties of the MCG are as yet active within the coverage area of the RNC 28, the RNC 28 must first perform the corresponding configurations necessary for setting up an MCG connection. In the process, the RNC 28 must somehow specify, among other things, the starting value for the MCG COUNT-C parameter 72.

The encryption of the MCG data can be performed either in the RLC 8 or in the MAC 10 of the second layer. The MCG COUNT-C value can be composed differently from the prior art depending on where the MCG data are encrypted. If the data are encrypted in the RLC 8, the MCG COUNT-C value 72 also consists of the RLC HFN and the RLC SQN, as in the prior art, but the RLC HFN does not need to be configured with a START value specific to UE 18 on initial sending of an MCG message. It can, instead, be configured with a random number or with a predefined value. If the MCG data are encrypted in the MAC 10 of the second layer, the MCG COUNT-C value 72 consists exclusively of a 32-bit long number which is configured either with a random number or a predefined value when the first message for an MCG is sent.

The MCG COUNT-C value 72 thus determined and the MCG CK are then sent by the RNC 28 in an MCG connection set up message 94 via a dedicated channel protected against interception by unauthorized persons to the UE 18. If the data are encrypted in the RLC 8, it is only necessary to transmit the RLC HFN of the MCG COUNT-C to the UE 18 because the RLC SQN of the data packets generally is not encrypted and can, therefore, be determined by the UE 18. This message is encrypted with the cipher key CK 46 specific to the UE 18, which already has been negotiated between the network and UE 18. The MCG CK and the COUNT-C value of the MCG thus can-not be found out by unauthorized persons.

The UE 18 establishes the MCG CK and the COUNT-C value after it has received them from RNC 28 and can then receive all MC messages of the MCG on a common channel. It is also conceivable that the UE 18 stores the received MCG CK in the USIM in order to be able to use it again when a new transmission of MCG messages takes place.

In order to signal to the network whether the procedure for authentication and for conveying the MCG CK and the MCG COUNT-C value has been successful, the UE 18 lastly can send an MCG connection complete message 96 to the network. This can contain, among other things, for example, the reason for an unsuccessful progress of the procedure described.

FIG. 10 shows a variant of the subscriber authentication as described with reference to FIG. 9. This again presupposes that the MCC 82 contains the functions for the authentication of subscribers of an MCG and for generating MCG CK.

Here, too, the UE 18 signals the request for entering into an MCG by sending an MCG entry request message 84 to the RNC 28. Differently from the preceding variant, the latter, however, directly inquires from the MCC 82 whether the subscriber is authorized to receive messages from the requested MCG. This is achieved by the RNC 28 by sending an MCG authentication request message 88 to the MCC 82. After receiving an MCG authentication request, the MCC 82 checks via the identity of the mobile radio subscriber contained in the message, and the identity of the MCG, whether he/she is authorized to join the MCG. If the authorization exists, the MCC 82 determines the current MCG CK at the time and sends it to the RNC 28 together with the identity of the mobile radio subscriber and the identity of the MCG in an MCG authentication response message 90. In addition, the MCC 82 signals to the SGSN 22 via an MCG entry indication message 86 that the subscriber has joined the corresponding MCG. The SGSN 22 can, thus, again perform the configurations necessary for determining the charges incurred by the subscriber.

Once the RNC 28 has received the MCG CK from the MCC 82, the latter determines the current MCG COUNT-C value as already described in the first exemplary embodiment. The RNC 28 then sends the MCG CK and the MCG COUNT-C value or, respectively, only a part of the MCG COUNT-C value via a dedicated connection, protected against interception by unauthorized persons via the CK 46 specific to the UE 18, to the UE 18. After receiving the message, the UE 18 establishes the parameters needed for decrypting MC messages and is thus capable of decrypting all subsequent messages of the MCG received on a common channel.

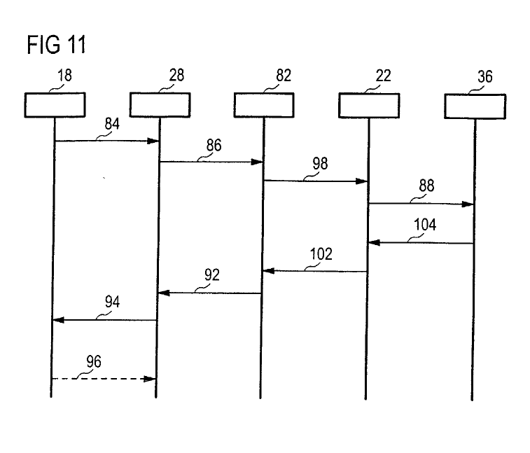

FIG. 11, finally, shows a subscriber authentication in the authentication center (AuC) 36 and a cipher key administration by the SGSN 22. It is assumed that the AuC 36 contains the functions for subscriber authentication and for generating MCG CKs as in the prior art, and the information as to which MCG CK is currently valid is kept in the SGSN 22.

The UE firstly again sends an MCG entry request message 84 to the RNC 28. After receiving such a message, the latter signals to the MCC 82 that a subscriber in its coverage area wishes to join a particular MCG. For this purpose, the RNC 28 sends an MCG entry indication message 86 to the MCC 82 which contains the identity of the mobile radio subscriber and the identity of the MCG. The RNC 28 has received these two parameters via the request of the UE 18. To determine the currently valid MCG CK, the MCC 82 thereupon sends an MCG CK request 98 to the SGSN 22 which again contains the user ID and MCG ID parameters. The SGSN 22 thereupon firstly inquiries from the AuC 36 via an MCG authentication request message 88 whether the subscriber is generally authorized for receiving messages from the corresponding MCG. If the AuC 36 receives an MCG authentication request message 88, it checks via the identities of the subscriber contained in the message and the MCG whether the subscriber is authorized to receive messages from the corresponding MCG. If there such an authorization for the subscriber, the AuC 36 acknowledges this to the SGSN 22 via an MCG authentication acknowledge message 104. The SGSN 22 can then again perform the necessary configurations which enable the network operator to determine the charges with respect to the MC service used. Furthermore, the SGSN 22 determines the currently valid MCG CK and sends it to the RNC 28 with the aid of an MCG CK response message 102. The RNC 28 then determines the current value of the MCG COUNT-C parameter as already described in the first exemplary embodiment. It then sends this or, respectively, only the RLC HFN of the MCG COUNT-C value, together with the MCG CK, via a dedicated transmission channel, protected against interception by unauthorized persons, to the UE 18. The UE 18 then responds to the reception of this message as already described in the first exemplary embodiment with respect to FIG. 9.

Although the present invention has been described with reference to specific embodiments, those of skill in the art will recognize that changes may be made thereto without departing from the spirit and scope of the present invention as set forth in the hereafter appended claims.

1. A method for conveying encryption information to parties in a multicast group in a mobile radio network, the method comprising the steps of:
allocating a connection, which is already protected against interception by unauthorized persons, as dedicated to a receiver of the encryption information; and
transmitting a cipher key and at least a part of a current encryption sequence number via an air interface and via the connection which is already protected against interception by unauthorized persons.

2. A method for conveying encryption information to parties in a multicast group in a mobile radio network as claimed in claim 1, wherein, during the transmission, a group-specific cipher key and a group-encryption sequence number are used.

3. A method for conveying encryption information to parties in a multicast group in a mobile radio network as claimed in claim 1, wherein multicast data of a plurality of multicast groups are sent time-interleaved via the same transmission channel.

4. A method for conveying encryption information to parties in a multicast group in a mobile radio network as claimed in claim 1, wherein subscriber authentication is effected by a multicast center network element which, among other things, is responsible for administering and controlling specific information of a party in the multicast group.

5. A method for conveying encryption information to parties in a multicast group in a mobile radio network as claimed in claim 1, wherein the cipher key is administered by a multicast center network element which, among other things, is responsible for administering and controlling specific information of a party in the multicast group.

6. A method for conveying encryption information to parties in a multicast group in a mobile radio network as claimed in claim 1, wherein subscriber authentication is effected in an authentication center of the mobile radio network.

7. A method for conveying encryption information to parties in a multicast group in a mobile radio network as claimed in claim 6, wherein the cipher key is administered in a serving GPRS node of the mobile radio network.

8. A method for conveying encryption information to parties in a multicast group in a mobile radio network as claimed in claim 2, wherein transmission of the group-specific cipher key and the group-specific encryption sequence number is triggered by a request coming from a subscriber joining the multicast group.

9. A method for conveying encryption information to parties in a multicast group in a mobile radio network as claimed in claim 2, wherein transmission of the group-specific cipher key and the group-specific encryption number is initiated by a network element which, among other things, is responsible for administering and controlling specific information of a party in the multicast group.
